(19) United States
(12) Patent Application Publication
(10) Pub. No.: US 2022/0152645 A1
(43) Pub. Date: May 19, 2022

(54) FLUID MATERIAL APPLICATION DEVICE

(71) Applicant: MITSUBISHI HEAVY INDUSTRIES, LTD., Tokyo (JP)

(72) Inventor: Michinobu TAKAHAGI, Tokyo (JP)

(21) Appl. No.: 17/433,052

(22) PCT Filed: Jan. 27, 2020
(86) PCT No.: PCT/JP2020/002751

§ 371 Date: Aug. 23, 2021

(30) Foreign Application Priority Data
Feb. 27, 2019 (JP) 2019-034448

(51) Int. Cl. B05C 1/02

(52) U.S. Cl. CPC B05C 1/02

(57) ABSTRACT

The purpose of the present invention is to hold a fluid material repeatedly with a stable volume and stably coat the fluid material on an object being coated. A sealant coating device includes a chamber in which a sealant is stored; a shaft that is inserted in and withdrawn from the chamber; and a transfer part that moves toward and away from the shaft, which is protruding from the chamber, and is capable of holding sealant which is adhering to the shaft. The transfer part is moved to a fastener and may move toward and away from the fastener.

### TECHNICAL FIELD

The present disclosure relates to a fluid material application device.

### BACKGROUND ART

When aircraft components such as fuselage panels and wings are manufactured, fastening components (fasteners) such as rivets and titanium bolts are used to connect members such as skins, frames and stringers to each other. When the fastener is installed in and fastened to the member, a gap between the fastener and a fastener installation hole is filled with a sealant. In this manner, the manufactured aircraft components can have improved corrosion resistance against rust or electrolytic corrosion.

PTL 1 below discloses is a technique relating to a seal application device in which the fastener is rotated around a central axis. While a nozzle is moved parallel to an axial direction of the fastener, the sealant is discharged from the nozzle to apply the sealant.

### CITATION LIST

### Patent Literature

[PTL 1] Japanese Unexamined Patent Application Publication No. 2012-239994

### SUMMARY OF INVENTION

### Technical Problem

In some cases, fastening apparatuses used when fasteners are inserted into members are previously filled with a plurality of the fasteners, thereby enabling fastening to be continuously performed in a short time. The devices are called automatic fastening apparatuses (automatic riveters). The seal application device disclosed in PTL 1 requires a mechanism for rotating the fastener around a central axis, and is less likely to be mounted on the automatic fastening apparatus.

In addition, there is a method of applying a sealant to an outer peripheral surface of a fastener shaft portion by using a seal application device including a cylinder. The seal application device fills the cylinder with the sealant, pushes out a predetermined amount of the sealant with a piston driven by a servo motor, and discharges the sealant from a nozzle. In this case, the sealant discharged from the nozzle is pressed against an outer peripheral surface of the fastener shaft portion, and is applied in a dot shape to the fastener which is not yet used for the fastening and disposed at a tip position of the automatic fastening apparatus.

However, even when a target amount (for example, a minimum amount that satisfies standards relating to a sealant application amount) required for application on the outer peripheral surface of the fastener shaft portion is discharged, all of the discharged sealant are not applied to the fastener shaft portion due to adhesiveness of the sealant. Consequently, the remaining sealant adheres to a periphery of the nozzle. As a result, in some cases, the adhering sealant may be supplied to the fastener, and may be applied beyond the target amount required for the application.

In addition, viscosity of the sealant varies with the lapse of time. Consequently, there is a problem in that a discharge state is not stable. Furthermore, when a discharge amount does not reach the target amount required for the application, and is set to be more than the target amount in anticipation of an insufficient application amount, an unnecessarily protruding sealant needs to be manually removed. Due to this cleaning process, it takes a lot of time and effort to fasten the fasteners.

The present disclosure is made in view of the above-described circumstances, and aims to provide a fluid material application device capable of repeatedly holding a stable amount of a fluid material, and stably applying the fluid material to an application target.

### Solution to Problem

According to the present disclosure, there is provided a fluid material application device including a storage unit that stores a fluid material, a rod-shaped member that moves into and out from the storage unit, and a transfer unit capable of holding the fluid material by moving away from and moving close to the rod-shaped member protruding from the storage unit so that the fluid material adhering to the rod-shaped member is transferred to the transfer unit.

According to this configuration, the fluid material is stored in the storage unit, and the rod-shaped member moves in and out from the storage unit. When the rod-shaped member is accommodated in the storage unit, the fluid material adheres to an outer peripheral surface of the rod-shaped member. The rod-shaped member protrudes from the storage unit at a position where the transfer unit is away from the rod-shaped member. Accordingly, the rod-shaped member to which the fluid material adheres is disposed outside the storage unit. When the transfer unit moves close to the rod-shaped member to which the fluid material adheres, the fluid material adhering to the rod-shaped member is transferred to the transfer unit, and the fluid material is held in the transfer unit.

In the fluid material application device according to the above-described disclosure, the transfer unit may be moved to an application target to be close to and away from the application target.

According to this configuration, the transfer unit which holds the fluid material is moved to the application target, to be close to and away from the application target. Accordingly, the fluid material can adhere to the application target.

In the fluid material application device according to the above-described disclosure, the transfer unit may have a pair of openable and closeable columnar members, and the columnar members may be capable of pinching the rod-shaped member therebetween.

According to this configuration, the transfer unit can be close to or away from the rod-shaped member by closing or opening the columnar members of the transfer unit. When the transfer unit is closed, the rod-shaped member is pinched between the columnar members of the transfer unit. When the fluid material adheres to the rod-shaped member, the fluid material is transferred to the transfer unit.

In the fluid material application device according to the above-described disclosure, a recessed portion having a shape corresponding to the rod-shaped member may be formed in the transfer unit.

According to this configuration, the recessed portion is formed in the transfer unit, and the fluid material is held in the recessed portion.

In the fluid material application device according to the above-described disclosure, the transfer unit may have a groove which is recessed from a surface closest to the rod-shaped member and in which the fluid material is held.

According to this configuration, the groove is formed in the transfer unit, and the fluid material is easily held in the transfer unit. In addition, when the fluid material is transferred from the rod-shaped member or the fluid material is transferred to the application target, the fluid material less likely to be sticky.

### Advantageous Effects of Invention

According to the present disclosure, a stable amount of the fluid material can be repeatedly held, and the fluid material can be stably applied to the application target.

### BRIEF DESCRIPTION OF DRAWINGS

FIG. 1 is a schematic front view illustrating a sealant application device according to an embodiment of the present disclosure, in which a chamber is illustrated in a sectional view.

FIG. 2 is a plan view illustrating a transcription chuck of the sealant application device according to the embodiment of the present disclosure.

FIG. 2 is a longitudinal sectional view taken along line III-III in FIG. 2.

FIG. 4 is a schematic front view illustrating the sealant application device according to the embodiment of the present disclosure.

FIG. 5 is a plan view illustrating the transcription chuck of the sealant application device according to the embodiment of the present disclosure.

FIG. 6 is a plan view illustrating the transcription chuck of the sealant application device according to the embodiment of the present disclosure.

FIG. 7 is a plan view illustrating the transcription chuck of the sealant application device according to the embodiment of the present disclosure.

FIG. 8 is a schematic front view illustrating the sealant application device according to the embodiment of the present disclosure.

FIG. 9 is a schematic front view illustrating the sealant application device according to the embodiment of the present disclosure.

FIG. 10 is a plan view illustrating the transcription chuck of the sealant application device according to the embodiment of the present disclosure.

FIG. 11 is a plan view illustrating the transcription chuck of the sealant application device according to the embodiment of the present disclosure.

FIG. 12 is a schematic front view illustrating the sealant application device according to the embodiment of the present disclosure.

FIG. 13 is a plan view illustrating the transcription chuck of the sealant application device according to the embodiment of the present disclosure.

### DESCRIPTION OF EMBODIMENTS

First, a sealant application device 1 according to an embodiment of the present disclosure will be described.

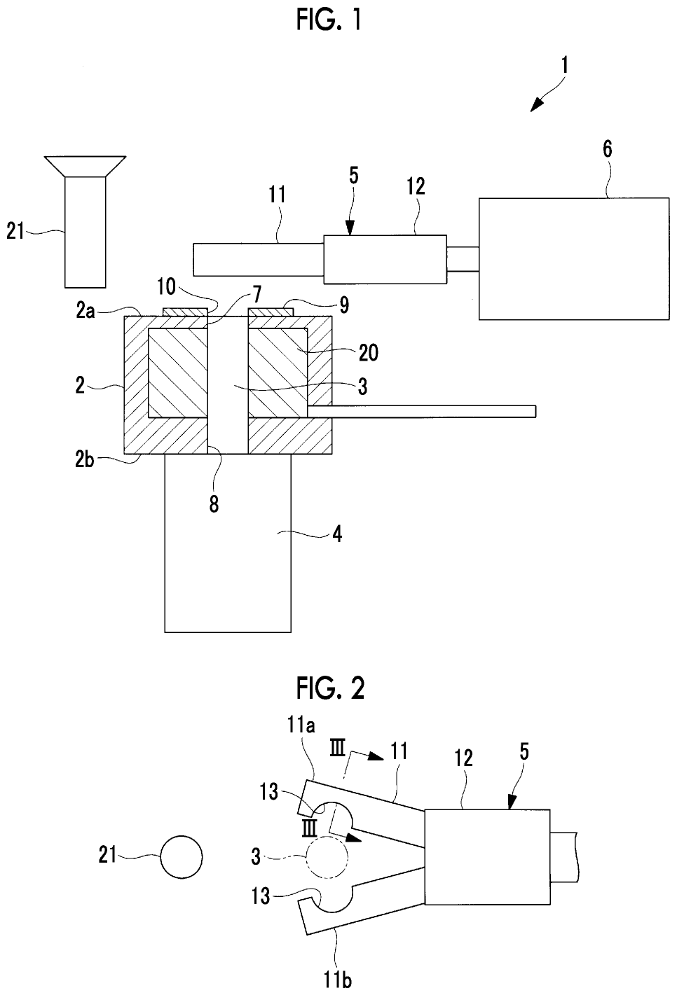

As illustrated in FIGS. 1 and 2, the sealant application device 1 according to the present embodiment includes a chamber 2, a shaft 3, a shaft drive unit 4, a transcription chuck 5, and a transcription chuck drive unit 6. The sealant application device 1 applies a sealant 20 to a fastener 21 serving as an application target via the transcription chuck 5. Here, a case will be described where the application target is a fastener (for example, a rivet or a bolt). However, the application target of the present disclosure is not limited to the fastener. For example, the sealant 20 is a material containing a polysulfide system as a main component.

The chamber 2 is a container that accommodates the sealant 20, and has a cylindrical shape, for example. Through-holes 7 and 8 are formed on two surfaces (first surface 2a and second surface 2b) facing each other in the chamber 2, and the shaft 3 can move in an axial direction in the through-holes 7 and 8. It is desirable that the chamber 2 always accommodates an appropriate amount of the sealant 20 so that the sealant 20 can properly adhere to an outer peripheral surface of the shaft 3.

The shaft 3 is a rod-shaped member, and has a circular cross section, for example. An outer diameter of the shaft 3 is substantially the same as an outer diameter of the fastener 21 to which the sealant 20 is applied.

One end (base end) side of the shaft 3 is connected to the shaft drive unit 4, and the shaft 3 can move parallel to the axial direction by the shaft drive unit 4. The other end (tip) side of the shaft 3 moves into and out from the through-hole 7 formed on the first surface 2a of the chamber 2. The shaft 3 can be moved to a position where the other end of the shaft 3 fits inside the chamber 2. In addition, the shaft 3 can move to a position where the outer peripheral surface of the shaft 3 is exposed and the sealant 20 can be transferred to the transcription chuck 5.

The shaft drive unit 4 is installed on the second surface 2b side of the chamber 2, and has a configuration in which the shaft 3 can move parallel to the axial direction of the shaft 3.

A scraper 9 is installed around the through-hole 7 formed on the first surface 2a of the chamber 2. The scraper 9 has a circular hole 10, and the shaft 3 moves into and out from the hole 10. An inner diameter of the hole 10 is smaller than an inner diameter of the through-hole 7, and is larger than the outer diameter of the shaft 3. The scraper 9 scrapes off the extra sealant 20 adhering to the outer peripheral surface of the shaft 3 protruding out of the chamber 2. In this manner, a film thickness of the sealant 20 adhering to the shaft 3 can be uniform in a circumferential direction.

The transcription chuck 5 has a transfer unit 11 and a support portion 12 that supports one end side of the transfer unit 11. The transfer unit 11 includes two columnar members 11a and 11b, and the two columnar members 11a and 11b have a structure that can be opened and closed by pivoting around the support portion 12 as a fulcrum. The sealant 20 adhering to the shaft 3 is transferred from the shaft 3, and adheres to facing surfaces on which the columnar members 11a and 11b face each other. A semicircular recessed portion 13 is formed on the facing surface to correspond to the outer peripheral surface of the shaft 3. The recessed portion 13 has a semi-cylindrical inner surface, for example. The sealant 20 is held by adhering to an inner surface of the recessed portion 13.

As illustrated in FIG. 3, a groove 14 may be formed along the circumferential direction at a center of the recessed portion 13 in a height direction. The groove 14 is recessed from a surface closest to the shaft 3 in the transfer unit 11. A cross-sectional shape of the groove 14 is a V-shape, for example. Since the groove 14 is formed, the sealant 20 is easily held on the facing surface of the transfer unit 11. In addition, when the sealant 20 is transferred from the shaft 3 or the sealant 20 is transferred to the fastener 21, the sealant 20 is less likely to be sticky.

The transcription chuck drive unit 6 has a mechanism for opening and closing the transcription chuck 5 and a mechanism for moving the transcription chuck 5. The transcription chuck drive unit 6 drives the transcription chuck 5 to open and close the transcription chuck 5, or move the transcription chuck 5. For example, the transcription chuck drive unit 6 opens the transcription chuck 5 when the transcription chuck 5 is moved close to the shaft 3, or closes the transcription chuck 5 when the transcription chuck 5 is moved away from the shaft 3. In addition, the transcription chuck drive unit 6 moves the transcription chuck 5 between a position where the shaft 3 protrudes and a position where the fastener 21 is installed.

Next, a sealant application method using the sealant application device 1 according to the embodiment of the present disclosure will be described.

First, the sealant 20 is supplied into the chamber 2. The chamber 2 is internally adjusted so that a proper amount of the sealant 20 is always accommodated therein.

As illustrated in FIG. 1, the shaft 3 is disposed inside the chamber 2, and the sealant 20 is caused to adhere to the outer peripheral surface of the shaft 3. In this case, as illustrated in FIG. 2, the transcription chuck 5 is moved to the position where the shaft 3 protrudes, and when the shaft 3 protrudes, the transcription chuck 5 is in an open state not to collide with the shaft 3. In addition, the fastener 21 to which the sealant 20 is applied is installed at a predetermined position.

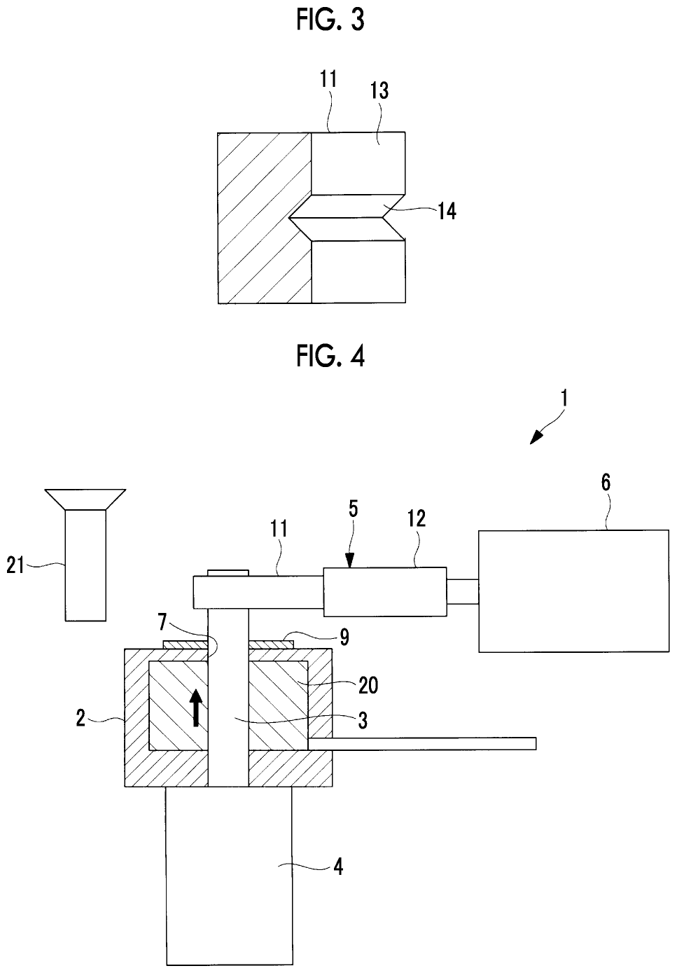

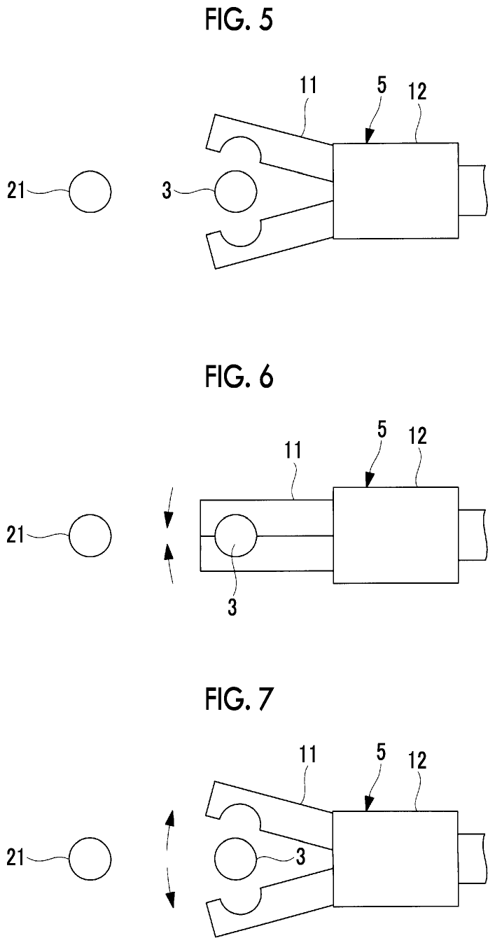

Next, as illustrated in FIGS. 4 and 5, the shaft 3 is protruded from the chamber 2. In this case, the sealant 20 is in a state of adhering to the outer peripheral surface of the shaft 3. The extra sealant 20 is scraped off by the scraper 9 installed in the through-hole 7 so that the sealant 20 having a predetermined film thickness uniformly adheres to the outer peripheral surface of the shaft 3.

After the shaft 3 having the sealant 20 adhering to the outer peripheral surface is exposed, the transcription chuck 5 is moved and closed in a direction close to the shaft 3, as illustrated in FIG. 6. In this manner, the transcription chuck 5 is in a state of pinching the shaft 3. Then, as illustrated in FIG. 7, the transcription chuck 5 is moved and opened in a direction away from the shaft 3. In this manner, the sealant 20 adhering to the outer peripheral surface of the shaft 3 is transferred to the facing surface of the transfer unit 11 of the transcription chuck 5, and the sealant 20 adheres to the facing surface.

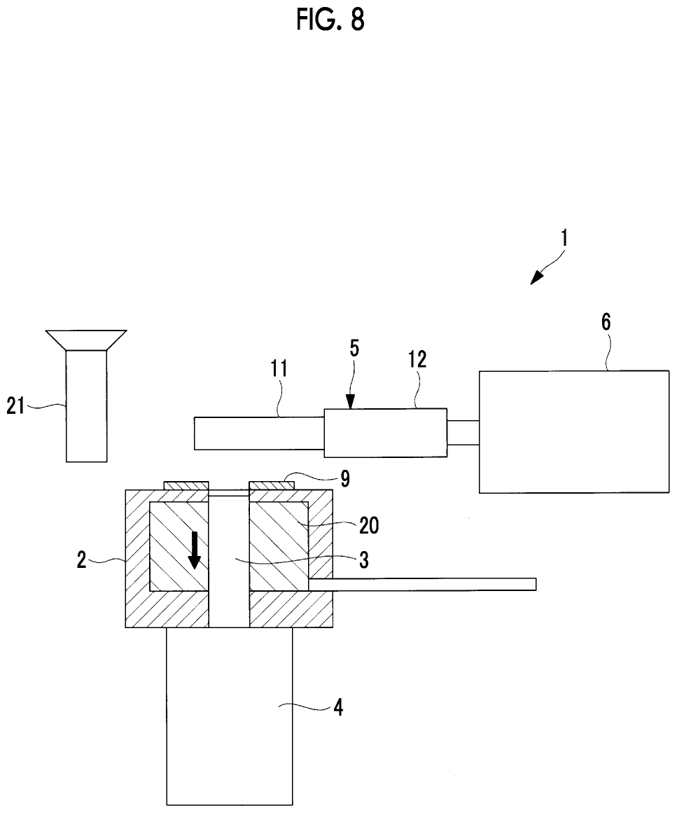

After the transcription chuck 5 is opened, as illustrated in FIG. 8, the shaft 3 is moved into the chamber 2, and the shaft 3 is accommodated inside the chamber 2.

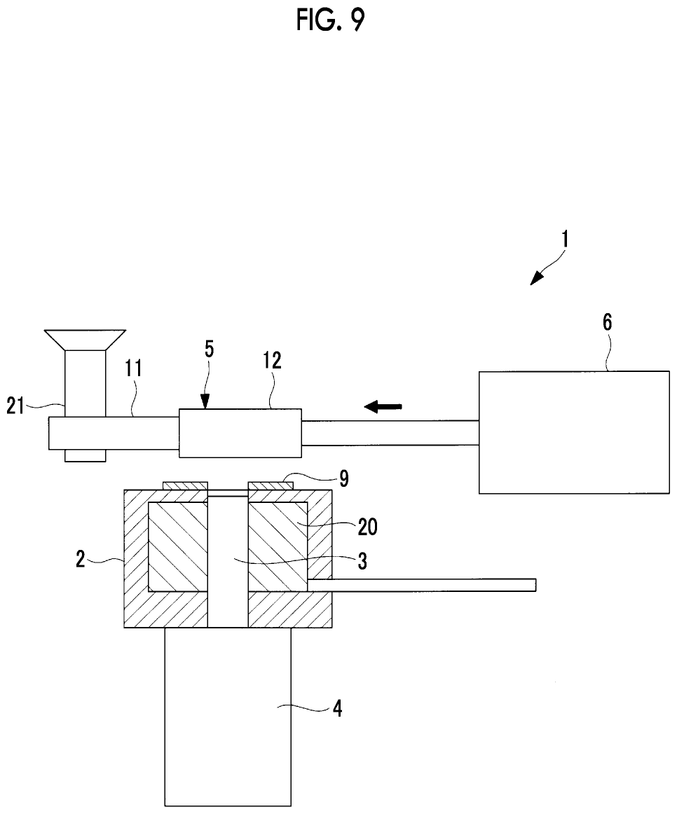

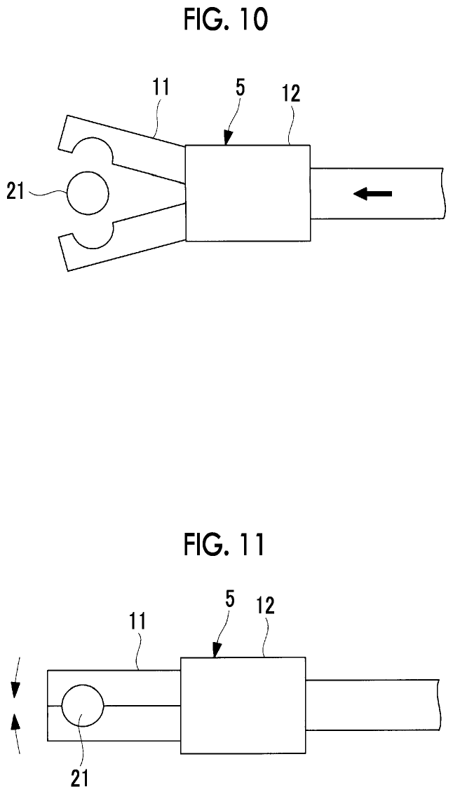

Thereafter, the transcription chuck 5 having the sealant 20 adhering to the facing surface is moved to the position where the fastener 21 is installed, as illustrated in FIGS. 9 and 10. Then, as illustrated in FIG. 11, the transcription chuck 5 is moved and closed in a direction close to the fastener 21. In this manner, the transcription chuck 5 is in a state of pinching the fastener 21. Then, the transcription chuck 5 is moved and opened in a direction away from the fastener 21. In this manner, the sealant 20 adhering to the facing surface of the transcription chuck 5 is transferred to the outer peripheral surface of the fastener 21, and the sealant 20 adheres to the outer peripheral surface of the fastener 21.

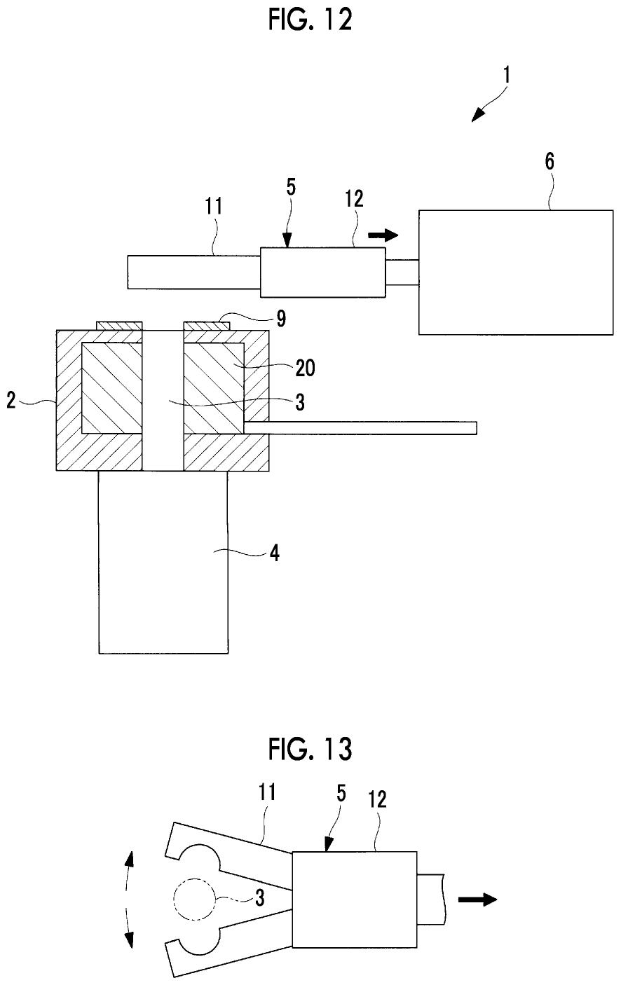

After the transcription chuck 5 is opened, the fastener 21 is moved to a fastening position, and is fastened by a fastening apparatus. In addition, as illustrated in FIGS. 12 and 13, the transcription chuck 5 is moved to an original position where the chamber 2 is installed, and is brought into a state where the sealant 20 can be transferred from the shaft 3 again.

As described above, according to the present embodiment, when the transcription chuck 5 comes into contact with the shaft 3 to which the sealant 20 adheres, the sealant 20 adhering to the shaft 3 is transferred to the transcription chuck 5, and the sealant 20 is held in the transcription chuck 5. Then, the fastener 21 is pinched by the transcription chuck 5 to which the sealant 20 adheres. In this manner, the sealant 20 adhering to the transcription chuck 5 is transferred to the fastener 21, and the sealant 20 adheres to the outer peripheral surface of the fastener 21. The sealant 20 is transferred by moving the transcription chuck 5 close to and away from the outer peripheral surface of the fastener 21. Accordingly, the sealant 20 does not adhere to the outer peripheral surface of the fastener 21 more than necessary. In addition, substantially the same amount of the sealant 20 is always transferred from the shaft 3 to the facing surface of the transcription chuck 5, and substantially the same amount of the sealant 20 is transferred from the transcription chuck 5 to the fastener 21. That is, the transfer unit 11 can repeatedly hold a stable amount of the sealant 20. Accordingly, the sealant 20 can be stably applied to the fastener 21.

In the above-described embodiment, an example has been described in which the transcription chuck drive unit 6 moves only in the horizontal direction. However, the present disclosure is not limited to this example. For example, the transcription chuck drive unit 6 may have a configuration in which the transcription chuck drive unit 6 can move between the fastener 21 and the shaft 3 not only in the horizontal direction but also in a direction perpendicular to the horizontal direction. In addition, in the above-described embodiment, a case has been described where the transcription chuck 5 moves toward the fastener 21. However, the present disclosure is not limited to this example. For example, the fastener 21 may have a configuration in which the fastener 21 moves toward an installation position of the transcription chuck 5.

In addition, in the above-described embodiment, a case has been described where the transfer unit 11 has an openable and closeable configuration. However, the present disclosure is not limited to this example. For example, other configurations may be adopted as long as the storage unit can move away from and close to the shaft 3, and the sealant 20 adhering to the shaft 3 can be transferred to hold the sealant 20.

### REFERENCE SIGNS LIST

1: sealant application device (fluid material application device)

2: chamber (storage unit)

2a: first surface

2b: second surface

3: shaft (rod-shaped member)

4: shaft drive unit

5: transcription chuck

6: transcription chuck drive unit

7, 8: through-hole

9: scraper

10: hole

11: transfer unit

11a, 11b: columnar member

12: support portion

13: recessed portion

14: groove

20: sealant (fluid material)

21: fastener

1. A fluid material application device comprising:
a storage unit that stores a fluid material;
a rod-shaped member that moves into and out from the storage unit; and
a transfer unit capable of holding the fluid material by moving away from and moving close to the rod-shaped member protruding from the storage unit so that the fluid material adhering to the rod-shaped member is transferred to the transfer unit.

2. The fluid material application device according to claim 1,
wherein the transfer unit is moved to an application target to be close to and away from the application target.

3. The fluid material application device according to claim 1,
wherein the transfer unit has a pair of openable and closeable columnar members, and the columnar members are capable of pinching the rod-shaped member therebetween.

4. The fluid material application device according to claim 1,
wherein a recessed portion having a shape corresponding to the rod-shaped member is formed in the transfer unit.

5. The fluid material application device according to claim 1,
wherein the transfer unit has a groove which is recessed from a surface closest to the rod-shaped member and in which the fluid material is held.

6. The fluid material application device according to claim 2,
wherein the transfer unit has a pair of openable and closeable columnar members, and the columnar members are capable of pinching the rod-shaped member therebetween.

7. The fluid material application device according to claim 2,
wherein a recessed portion having a shape corresponding to the rod-shaped member is formed in the transfer unit.

8. The fluid material application device according to claim 3,
wherein a recessed portion having a shape corresponding to the rod-shaped member is formed in the transfer unit.

9. The fluid material application device according to claims 2,
wherein the transfer unit has a groove which is recessed from a surface closest to the rod-shaped member and in which the fluid material is held.

10. The fluid material application device according to claim 3,
wherein the transfer unit has a groove which is recessed from a surface closest to the rod-shaped member and in which the fluid material is held.

11. The fluid material application device according to claim 4,
wherein the transfer unit has a groove which is recessed from a surface closest to the rod-shaped member and in which the fluid material is held.
